(19) United States
(12) Patent Application Publication
(10) Pub. No.: US 2025/0168656 A1
(43) Pub. Date: May 22, 2025

(54) FIRST WIRELESS DEVICE, FIRST NETWORK NODE, AND METHODS PERFORMED THEREBY, FOR HANDLING AN INDICATION

(71) Applicant: Telefonaktiebolaget LM Ericsson (publ), Stockholm (SE)

(72) Inventors: Antonino Orsino, Kirkkonummi (FI); Tuomas Tirronen, Helsinki (FI)

(21) Appl. No.: 18/836,150

(22) PCT Filed: Feb. 6, 2023
(86) PCT No.: PCT/SE2023/050098

§ 371 Date: Aug. 6, 2024

Related U.S. Application Data
(60) Provisional application No. 63/267,613, filed on Feb. 7, 2022.

(51) Int. Cl. H04W 24/02; H04W 24/10; H04W 36/00; H04W 36/08

(52) U.S. Cl. CPC H04W 24/02; H04W 24/10; H04W 36/0058; H04W 36/08

(57) ABSTRACT

A method performed by a first wireless device (111). The first wireless device (111) operates in a wireless communications network (100). The first wireless device (111) obtains (201) first information indicating whether or not a first cell (121) supports service to a first wireless device (131) having a reduced capability. The first wireless device (111) also sends (203) a first indication to a first network node (111). The first wireless device (131) is served by the first network node (111). The first cell (121) is served by a second network node (112). The first indication indicates one or more measurements on one or more cells (120). With the proviso the first information indicates the first cell (121) lacks support for the first wireless device (131) having the reduced capability, the first wireless device (131) refrains from indicating any measurements performed on the first cell (121 in the first indication.

### TECHNICAL FIELD

The present disclosure relates generally to a first wireless device and methods performed thereby for handling an indication. The present disclosure further relates generally to a first network node and methods performed thereby, for handling the indication.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

### Internet of Things (IoT)

The Internet of Things (IoT) may be understood as an internetworking of communication devices, e.g., physical devices, vehicles, which may also referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Fifth Generation (5G) is the fifth generation of cellular technology and was introduced in Release 15 of the 3GPP standard. It is designed to increase speed, reduce latency, and improve flexibility of wireless services. The 5G system (5GS) may include both a new radio access network (NG-RAN) which may make use of a new air interface called New Radio (NR), and a new core network (5GC), which may be referred to as Next Generation (NG) Core Network, abbreviated as NG-CN, NGC or 5G CN.

The initial release of 5G in Release 15 is optimized for mobile broadband (MBB) and ultra-reliable and low latency communication (URLLC). These services may require very high data rates and/or low latency and may therefore place high requirements on a UE. To enable 5G to be used for other services with more relaxed performance requirements, a new low complexity UE type is introduced in Release 17, which may be referred to as ‘reduced capability NR devices’ or RedCap. The low complexity UE type may be understood to be particularly suited for machine type communication (MTC) services, such as wireless sensors or video surveillance, but it may also be used for MBB services with lower performance requirements, such as wearables. The low complexity UE may be understood to have reduced capabilities compared to a Release 15 NR UE, such as reduced UE bandwidth, reduced number of UE Receive, receiver (RX)/Transmit, transmitter (TX) antennas, and half duplex Frequency Division Duplex (FDD). A full detail description may be found on the Rel-17 work item description in RP-211574.

Because of the reduced capabilities, the low complexity UE may be sometimes also referred to as an NR RedCap UE. An NR RedCap UE may have some or all of the reduced capabilities above.

The work in 3GPP related to RedCap is, at the moment, planned to cover only networks supporting NR and 5GC.

Existing methods to perform communications with RedCap UEs may incur in long connectivity interruption, higher power consumption and higher signaling overhead on both, the network and the UE.

### SUMMARY

As part of the development of embodiments herein, one or more challenges with the existing technology will first be identified and discussed.

In the last RAN2 #116-bis-e meeting, it was discussed how a RedCap UE and the network may need to handle the case of when a RedCap UE may be handed off from LTE to NR, and the selected NR cell may be a legacy cell. After the discussion, the following agreement was taken: For the LTE to NR handover, in case the target NR cell is a legacy cell, the RedCap UE should trigger Radio Resource Control (RRC) re-establishment procedure. For further study (FFS) any specification impact or purely leave to implementation.

However, this agreement has some flaws that still need to be addressed. One flaw is that, from a network perspective, a target network node, of a release that may be previous to the one in which RedCap has been specified, during handover, cannot realize whether the UE that may need to be handed off is a RedCap UE or not. This may be understood to be because a target node of a 3GPP release “X” may not be able to understand features that may be specificized in 3GPP release “X+1” and later. RedCap may be understood to be targeted for Rel-17. Therefore, nodes supporting functionality specified in previous releases may be understood to not implement support for RedCap, and do not understand how a RedCap UE may be restricted compared to other UEs.

Further, a target network node of a release that may be previous to the one in which RedCap has been specified, during handover, may still be able to comply with the UE capabilities, even if this UE is a RedCap UE. This may be because the features supported by a RedCap UE most of the time may be just a subset of the features supported in general by NR. According to this, if the above agreement is followed, the RedCap UE should trigger RRC re-establishment procedure, but this may be difficult to do for the UE because the RedCap UE may not know whether the target network node supports RedCap or not, until System Information Block 1 (SIB1) may be read. SIB1 reading may be typically done after the handover may have been completed.

It is therefore an object of embodiments herein to improve the handling of signalling between a network node and a wireless device having reduced capability.

According to a first aspect of embodiments herein, the object is achieved by a method, performed by a first wireless device. The method is for handling an indication. The first wireless device operates in a wireless communications network. The first wireless device obtains first information indicating whether or not a first cell supports service to the first wireless device having a reduced capability with respect to a group of second wireless devices. The first wireless device then sends a first indication to a first network node. The first wireless device is served by the first network node and the first cell is served by a second network node. The first indication indicates one or more measurements performed by the first wireless device on one or more cells. With the proviso the first information indicates the first cell lacks support for the first wireless device having the reduced capability, the first wireless device refrains from indicating any measurements performed on the first cell to the first network node in the first indication.

According to a second aspect of embodiments herein, the object is achieved by a method, performed by the first network node. The method is for handling the indication. The first network node operates in the wireless communications network. The first network node sends, to the first wireless device, the first information indicating whether or not the first cell supports service to the first wireless device having the reduced capability with respect to the group of second wireless devices. The first network node serves the first wireless device and the first cell is served by the second network node. The first network node then receives the first indication from the first wireless device. The first indication indicates the one or more measurements performed by the first wireless device on the one or more cells. With the proviso the first information indicates the first cell lacks support for the first wireless device having the reduced capability. The first wireless device refrains from indicating any measurements performed on the first cell to the first network node in the first indication.

According to a third aspect of embodiments herein, the object is achieved by the first wireless device. The first wireless device may be understood to be for handling the indication. The first wireless device is configured to operate in the wireless communications network. The first wireless device is further configured to obtain the first information configured to indicate whether or not the first cell is configured to support service to the first wireless device 131 being configured to have the reduced capability with respect to the group of second wireless devices. The first wireless device is also configured to send the first indication to the first network node. The first wireless device is configured to be served by the first network node and the first cell is configured to be served by the second network node. The first indication is configured to indicate the one or more measurements configured to be performed by the first wireless device on the one or more cells. With the proviso the first information is configured to indicate the first cell lacks support for the first wireless device configured to have the reduced capability, the first wireless device is configured to refrain from indicating any measurements configured to be performed on the first cell to the first network node in the first indication.

According to a fourth aspect of embodiments herein, the object is achieved by the first network node. The first network node may be understood to be for handling the indication. The first network node is configured to operate in the wireless communications network. The first network node is configured to send, to the first wireless device, the first information configured to indicate whether or not the first cell is configured to support service to the first wireless device configured to have the reduced capability with respect to the group of second wireless devices. The first network node is configured to serve the first wireless device and the first cell is configured to be served by the second network node. The first network node is also configured to receive the first indication from the first wireless device. The first indication is configured to indicate the one or more measurements configured to be performed by the first wireless device on the one or more cells. With the proviso the first information is configured to indicate the first cell lacks support for the first wireless device configured to have the reduced capability, the first wireless device is configured to refrain from indicating any measurements performed on the first cell to the first network node in the first indication.

By obtaining the first information, the first wireless device may be enabled to use the first information to determine, whether or not the first cell may support service to the first wireless device having the reduced capability. This may in turn enable the first wireless device to know whether or not to indicate any measurements performed on the first cell to the first network node in the first indication.

By then sending the first indication to the first network node, and with the proviso the first information indicates the first cell lacks support for the first wireless device having the reduced capability, the first wireless device refrains from indicating any measurements performed on the first cell to the first network node in the first indication, the first wireless device may be understood to ultimately enable that the first wireless device having the reduced capability, e.g., a RedCap UE, may not be allowed to be handed off to a network node that may not support the reduced capability, e.g., RedCap, feature. This may be understood to prevent that the first wireless device having the reduced capability may operate in a network that may not support the feature, or alternatively, to trigger unnecessarily the RRC reestablishment procedure, thus enabling to save connectivity interruption, power consumption and signaling overhead, on both the network and the first wireless device.

By the first network node sending the first information to the first wireless device, the first network node may be understood to enable the first wireless device to determine, whether or not the first cell may support service to the first wireless device having the reduced capability. This may in turn enable the first wireless device to know whether or not to indicate any measurements performed on the first cell to the first network node in the first indication. By the first network node receiving the first indication indicating the one or more measurements performed by the first wireless device on the one or more cells, wherein with the proviso the first information indicates the first cell lacks support for the first wireless device having the reduced capability, the first wireless device refrains from indicating any measurements performed on the first cell to the first network node in the first indication, the first network node may be enabled to refrain from handing off the first wireless device to a network node that may not support the reduced capability, e.g., RedCap, feature. This may be understood to prevent that the first wireless device having the reduced capability may operate in a network that may not support the feature, or alternatively, to trigger unnecessarily the RRC reestablishment procedure, thus enabling to save connectivity interruption, power consumption and signaling overhead, on both the network and the first wireless device.

### BRIEF DESCRIPTION OF THE DRAWINGS

Examples of embodiments herein are described in more detail with reference to the accompanying drawings, according to the following description.

FIG. 1 is a schematic diagram an example of a wireless communications network, according to embodiments herein.

FIG. 2 is a flowchart depicting a method in a first wireless device, according to embodiments herein.

FIG. 3 is a flowchart depicting a method in a first network node, according to embodiments herein.

FIG. 4 is a schematic block diagram illustrating two embodiments, in panel a) and panel b), of a first wireless device, according to embodiments herein.

FIG. 5 is a schematic block diagram illustrating two embodiments, in panel a) and panel b), of a first network node, according to embodiments herein.

FIG. 6 is a schematic block diagram illustrating a telecommunication network connected via an intermediate network to a host computer, according to embodiments herein.

FIG. 7 is a generalized block diagram of a host computer communicating via a base station with a user equipment over a partially wireless connection, according to embodiments herein.

FIG. 8 is a flowchart depicting embodiments of a method in a communications system including a host computer, a base station and a user equipment, according to embodiments herein.

FIG. 9 is a flowchart depicting embodiments of a method in a communications system including a host computer, a base station and a user equipment, according to embodiments herein.

FIG. 10 is a flowchart depicting embodiments of a method in a communications system including a host computer, a base station and a user equipment, according to embodiments herein.

FIG. 11 is a flowchart depicting embodiments of a method in a communications system including a host computer, a base station and a user equipment, according to embodiments herein.

### DETAILED DESCRIPTION

Certain aspects of the present disclosure and their embodiments may provide solutions to these or other challenges. Embodiments herein may be generally understood to relate to handover of RedCap UEs to network nodes that may not support RedCap.

The methods described herein may be understood to aim to not allow a RedCap UE to be handed off to a network node that does not support the RedCap feature. In order to do so, at least one of the following options may be pursued. According to a first option, the RedCap UE, when performing inter-frequency and inter-RAT measurement, may report measurement results only for cells that support RedCap. In this case, it may be avoided a priori that the source network node may select, e.g., blindly, a target network node that does not support RedCap.

According to a second option, when receiving measurement results from a RedCap UE, the source network node when sending the handover request to the selected target network node may also include a request to know if the selected target network node supports RedCap or not. If the target network node does not support RedCap, the source network node may either choose another target network node or simply release the UE to RRC_INACTIVE or RRC_IDLE.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

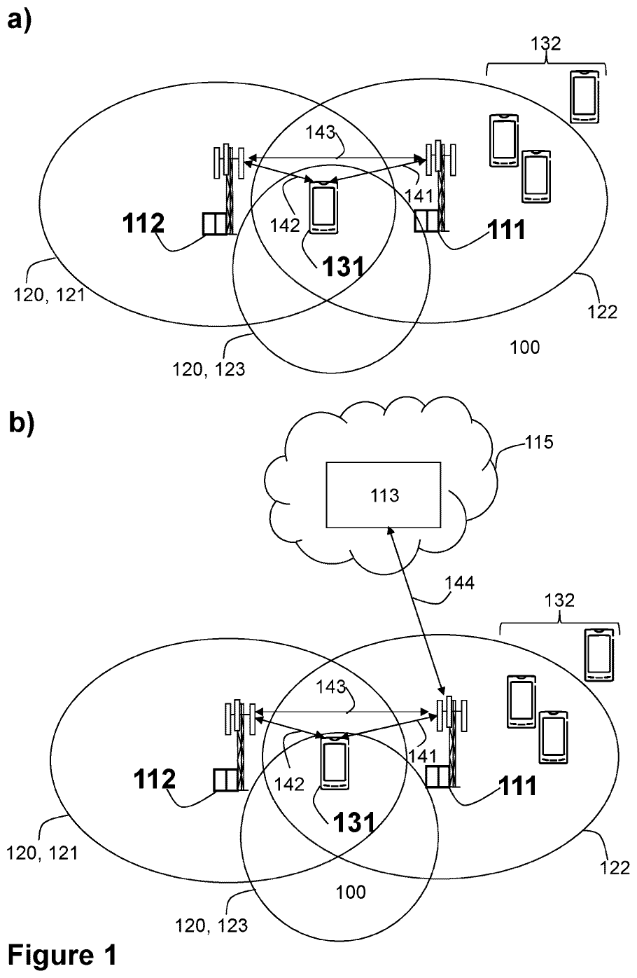

FIG. 1 depicts two non-limiting examples of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may instead, or in addition, support other technologies such as, for example, Long-Term Evolution (LTE), e.g., LTE for Machines (LTE-M), LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced LAA (eLAA), further enhanced LAA (feLAA) and/or MulteFire. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system, such as a younger system than 5G supporting equivalent functionality. The wireless communications network 100 may support MTC, eMTC, IoT and/or Narrow Band IoT (NB-IoT). Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a first network node 111 and a second network node 112 are depicted in the non-limiting example of FIG. 1. Any of the first network node 111 and the second network node 112 may be a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, such as that depicted in FIG. 1 b for the first network node 111, any of the first network node 111 and the second network node 112 may be a distributed node and may partially perform its functions in collaboration with a virtual node 113 in a cloud 115. In particular examples herein, the second network node 112 may be a network node of a release that may be previous to the one in which RedCap has been specified, e.g., a release previous to Rel-17. In particular examples herein, the first network node 111 may be a network node of Rel-17 or higher.

The wireless communications network 100 may cover a geographical area, which in some embodiments may be divided into cell areas, wherein each cell area may be served by a radio network node, although, one radio network node may serve one or several cells. In the example of FIG. 1, the wireless communications network 100 comprises one or more cells 120, comprising a first cell 121. The second network node 112 serves the first cell 121. The first network node 111 serves a second cell 122. The second cell 122 is comprised in the wireless communications network 100 but may or may not be comprised in the one or more cells 120. The one or more cells 120, in addition to the first cell 121 may comprise other cells such as, e.g., a third cell 123. It may be noted that the number and location of the one or more cells 120 in FIG. 1 is non-limiting and for illustrative purposes only.

Any of the first network node 111 and the second network node 112 may be of different classes, such as, e.g., macro eNodeB, home eNodeB or pico base station, based on transmission power and thereby also cell size. In some examples, any of the first network node 111 and the second network node 112 may serve receiving nodes with serving beams. Any of the first network node 111 and the second network node 112 may support one or several communication technologies, and its name may depend on the technology and terminology used. Any of the first network node 111 and the second network node 112 may be comprised in the wireless communications network 100 may be directly connected to one or more core networks.

A plurality of wireless devices may be located in the wireless communication network 100, whereof a first wireless device 131 and a group of second wireless devices 132 are depicted in the non-limiting example of FIG. 1. Any of the first wireless device 131 and the group of second wireless devices 132 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. The first wireless device 131 and the group of second wireless devices 132 comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. Any of the first wireless device 131 and the group of second wireless devices 132 comprised in the wireless communications network 100 may be enabled to communicate wirelessly in the wireless communications network 100. The communication may be performed e.g., via a RAN, and possibly the one or more core networks, which may comprise within the wireless communications network 100.

It may be noted that the number and location of the second wireless devices comprised in the group of second wireless devices 132 in FIG. 1 is non-limiting and for illustrative purposes only.

The first network node 111 may be understood as a source network node, and the second network node may be understood as a target network node, e.g., in a potential handover of the first wireless device 131. In some particular examples, the first network node 111 may operate on LTE and the second network node 112 may operate on NR.

The first wireless device 131 may be a wireless device of reduced capability, such as reduced UE bandwidth, reduced number of UE Receive, receiver (RX)/Transmit, transmitter (TX) antennas, and half duplex Frequency Division Duplex (FDD), in comparison to the group of second wireless devices 132. The first wireless device 131 may be, for example, a RedCap device, as described in the Rel-17 work item description in RP-211574. Any of the second wireless devices in the group of second wireless devices 132 may be, for example, a Release 15 NR UE.

The first wireless device 131 may be configured to communicate within the wireless communications network 100 with the first network node 111 over a first link 141, e.g., a radio link. The first wireless device 131 may be configured to communicate within the wireless communications network 100 with the second network node 112 over a second link 142, e.g., a radio link. The first network node 111 may be configured to communicate within the wireless communications network 100 with the second network node 112 over a third link 143, e.g., a radio link or a wired link. The first network node 111 may be configured to communicate within the wireless communications network 100 with the virtual network node 113 over a fourth link 144, e.g., a radio link or a wired link. Any of the second wireless devices in the group of second wireless devices 132 may be configured to communicate within the wireless communications network 100 with the first network node 111 or the second network node 112 over a respective first link, e.g., a radio link, which are not depicted in FIG. 1 to simplify the figure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a first wireless device, such as the first wireless device 131, e.g., a RedCap UE, and embodiments related to a first network node, such as the first network node 111, e.g., a gNB.

Some embodiments herein will now be further described with some non-limiting examples.

In the following description, any reference to a/the UE, or simply “UE” may be understood to equally refer the first wireless device 131; any reference to a/the gNB, a/the NW, a/the network and/or a/the source network node may be understood to equally refer to the first network node 111; any reference to a/the target network node, a/the “target NR node”, a/the “potential target network node” and/or a/the “legacy network node” node may be understood to equally refer to the second network node 112.

In the following description of embodiments herein, examples may be provided that may target as scenario the handover of a RedCap UE from LTE to NR, where the target NR node may not support the RedCap feature, e.g., because it may be implementing a 3GPP release that may be previous to the 3GPP release where RedCap has been specified. However, the same embodiments may be applied without any loss of meaning to any other case of handover where the target network node may be a node that does not support RedCap.

Also, embodiments herein may target the NR Radio Access Technology (RAT), but may also be applied without any loss of meaning to LTE or any other RAT supporting or not supporting RedCap.

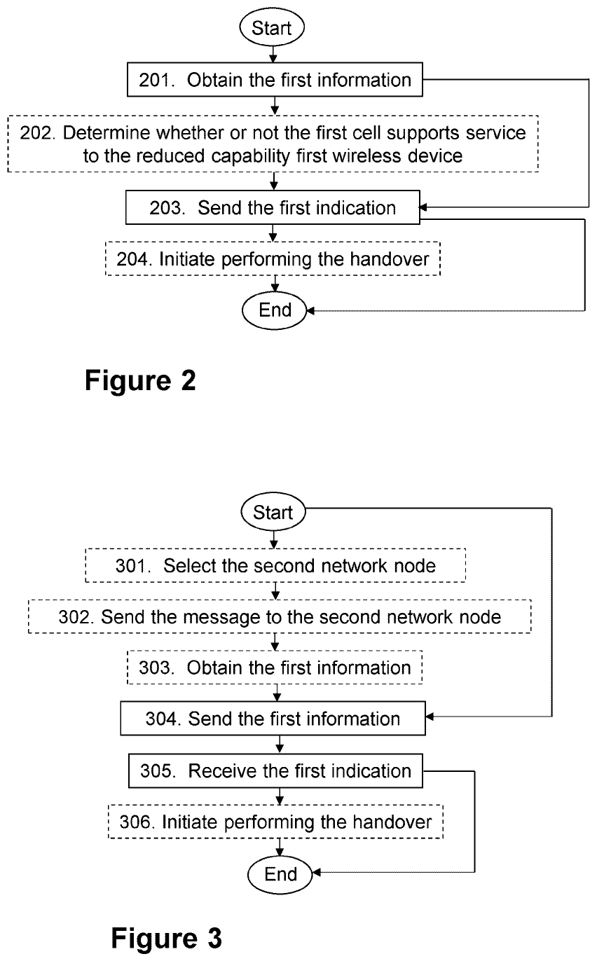

Embodiments of a method, performed by the first wireless device 131, will now be described with reference to the flowchart depicted in FIG. 2. The method is for handling an indication. The first wireless device 131 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some embodiments, the wireless communications network 100 may be a 5G network.

Several embodiments are comprised herein. In some embodiments, all the actions may be performed. In other embodiments, some of the actions may be performed. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. A non-limiting example of the method performed by the first wireless device 131 is depicted in FIG. 2. In FIG. 2, optional actions are represented with dashed lines. The actions may be performed in a different order than that depicted in FIG. 2.

### Action 201

In this Action 201, the first wireless device 131 obtains information, e.g., first information. The first information indicates whether or not the first cell 121 supports service to the first wireless device 131, that is, that may support the first wireless device 131. The first wireless device 131 has the reduced capability with respect to the group of second wireless devices 132.

As stated earlier, the reduced capability may be, such as reduced UE bandwidth, reduced number of UE Receive, receiver (RX)/Transmit, transmitter (TX) antennas, and half duplex Frequency Division Duplex (FDD), in comparison to the group of second wireless devices 132. The first wireless device 131 may be, for example, a RedCap device, as described in the Rel-17 work item description in RP-211574. Any of the second wireless devices in the group of second wireless devices 132 may be, for example, a Release 15 NR UE.

In particular examples, the first wireless device 131 may be a RedCap UE. In some particular examples, the first information may indicate whether or not the first cell 121 supports service to RedCap UEs.

Service may be understood herein as implementation or support of functionality to provide connectivity, e.g., to the first wireless device 131 having the reduced capability with respect to the group of second wireless devices 132.

The first cell 121 is served by the second network node 112.

Obtaining may comprise receiving, e.g., from the first network node 111, e.g., via the first link 141, or from the second network node 112, e.g., via the second link 142.

In some embodiments, the first information may be a configuration from the first network node 111. The first wireless device 131 is served by the first network node 111.

In some embodiments, the configuration may configure the first wireless device 131 to perform measurements on frequencies where cells supporting service to wireless devices with reduced capability may operate. Frequencies may be understood as radio frequencies.

In one example, the network, e.g., the first network node 111, may configure the first wireless device 131, e.g., a RedCap UE, to perform measurements, inter-frequency or inter-RAT, only on frequencies where cells supporting RedCap, may be operating. The network may know in advance on which frequency a cell supporting the reduced capability, e.g., RedCap, may operate by means e.g., of inter-node signaling, e.g., inter-node RRC message, X2/Xn signaling, or via Administration and Management (OAM) functions. In particular, a network node such as the first network node 111 may collect this information in previous network operations e.g., when adding a new secondary node, in previous handover of other UEs, or via the Self-Organizing Network (SON) and Minimization of Drive Test (MDT) framework, or Automatic Neighbour Relation (ANR).

The configuration, e.g., a measurement configuration, may comprise an indication, e.g., a second indication, such as a list, about which cell IDs may be those of cells that may already support the reduced capability, e.g., RedCap.

In some embodiments, the first information may be obtained from the first cell 121, e.g., in a broadcast from the first cell 121.

In some embodiments, the first information may be comprised in Master Information Block (MIB), e.g., one or more MIBs. In some embodiments, the first information may be comprised in System Information Block (SIB), e.g., one or more SIBs. In some embodiments, the first information may be comprised in SIB3/4, e.g., one or more SIBs3/4.

In another example, when performing measurements, inter-frequency and/or inter-RAT, for each cell that may operate in a frequency that has been measured, the first wireless device 131 may acquire the MIB of the cell, and check whether in the MIB there may be an information on whether this cell may support the reduced capability, e.g., RedCap or not.

Alternatively, for each cell that may operate in a frequency that may have been measured, the first wireless device 131 may acquire the System Information Block 1 (SIB1) of the cell and check whether in the SIB1 there may be any indication on whether the cell may support the reduced capability, e.g., RedCap of not.

In a yet another alternative, the first wireless device 131 may check other system information, e.g., SIB3/4, of cells, to find out whether a certain frequency may support the reduced capability, e.g., RedCap UEs or not. In yet another alternative, system information, e.g., SIB3/4, may be checked to determine which neighboring cells or a particular cell, may support the reduced capability, e.g., RedCap or not.

In one example, the first network node 111, when sending a measurement configuration to the RedCap UE, in the measurement configuration may add an indication about with cell Identities or Identifiers (IDs) may be those of cells that may already support RedCap.

In some embodiments, the first information may lack an indicator explicitly indicating that support for the reduced capability is provided. It has been agreed that a RedCap UE may need to check RedCap-specific Intra Frequency Reselection indicator (IFRI) in SIB1. If this IFRI is absent, the first wireless device 131 may assume the cell does not support RedCap.

By obtaining the first information in this Action 201, the first wireless device 131 may then be enabled to use the obtained first information to determine, in the next Action 202 whether or not the first cell 121 may support service to the first wireless device 131 having the reduced capability with respect to the group of second wireless devices 132. This may in turn enable the first wireless device 131 to know whether or not to refrain from indicating any measurements performed on the first cell to the first network node. This may be understood to ultimately enable that the first wireless device 131, e.g., a RedCap UE, may not be allowed to be handed off to a network node that may not support the reduced capability, e.g., the RedCap feature. This may be understood to prevent that the first wireless device 131, e.g., a RedCap UE, may operate in a network that may not support the feature, or alternatively, to trigger unnecessarily the RRC reestablishment procedure. This may be understood to in turn enable to save connectivity interruption, power consumption and signaling overhead, on both the network and the first wireless device.

### Action 202

In this Action 202, the first wireless device 131 may determine whether or not the first cell 121 may support service to the first wireless device 131 having the reduced capability with respect to the group of second wireless devices 132. The determining in this Action 202 may be based on the obtained first information.

Determining may be understood as e.g., calculating or checking.

In some embodiments, at least one of the following may apply: a) the first information may be comprised in MIB, b) the first information may be comprised in SIB, c) the first information may be comprised in SIB3/4; d) the first wireless device 131 may determine the first cell 121 may lack support for the service to the first wireless device 131 having the reduced capability based on the first information lacking the indicator explicitly indicating that support for the reduced capability is provided; and e) the first wireless device 131 may be a RedCap UE.

As explained earlier, system information, e.g., SIB3/4, may be checked to determine which neighboring cells or a particular cell, may support the reduced capability, e.g., RedCap or not. In this example, the first wireless device 131 may use any of the alternatives when determining whether to perform or report measurement results of such cells, cf. other examples.

In another example, when receiving the handover command from the first network node 111 as source network node, including a configuration generated by the target network node, such as e.g., the second network node 112, the first wireless device 131 may implicitly understand whether the target network node may support the reduced capability, e.g., RedCap, or not according to the presence of some specific reduced capability, e.g., RedCap configuration. A specific reduced capability, e.g., RedCap, configuration may be just a configuration that may be used for the reduced capability, e.g., RedCap, feature only and not for any other feature. In such a case, when the first wireless device 131 may figure out that the target node, e.g., the second network node 112, does not support the reduced capability, e.g., RedCap, the first wireless device 131 may simply trigger the RRC reestablishment procedure.

As stated earlier, in one example, the first network node 111, when sending a measurement configuration to the RedCap UE, in the measurement configuration may add an indication about with cell IDs may be those of cells that may already support RedCap. In this case, for the cell IDs that may support RedCap, that may be included in the list sent by the first network node 111, the first wireless device 131 may use such information to decide whether to understand if the cell may support RedCap or not via the acquisition of the MIB or SIB1.

In some embodiments, the first information may lack the indicator explicitly indicating that support for the reduced capability is provided. It has been agreed that a RedCap UE may need to check RedCap-specific Intra Frequency Reselection indicator (IFRI) in SIB1. If this IFRI is absent, the first wireless device 131 may assume the cell does not support RedCap. Additionally, it has been agreed SIB1 may indicate whether the cell may bar RedCap UEs supporting either 1 Receive (Rx) branch, 2 Rx branches, or all types of RedCap UEs. Yet, in another alternative, for a cell that may operate in a frequency that may have been measured, the first wireless device 131 may try to understand if the cell may support RedCap or not via the acquisition of the MIB or SIB1 only if this may have been indicated by the first network node 111 in the measurement configuration.

By, in this Action 202, determining whether or not the first cell 121 may support service to the first wireless device 131 having the reduced capability, the first wireless device 131 may be enabled to know whether or not to refrain from indicating any measurements performed on the first cell to the first network node. With the proviso the first information indicates the first cell 121 lacks support for the first wireless device 131 having the reduced capability, the first wireless device 131 may then refrain from indicating any measurements performed on the first cell 121 to the first network node 111. This may ultimately enable that the first wireless device 131, e.g., a RedCap UE, may not be allowed to be handed off to a network node that may not support the reduced capability, e.g., the RedCap feature. This may be understood to prevent that the first wireless device 131, e.g., a RedCap UE, may operate in a network that may not support the feature, or alternatively, to trigger unnecessarily the RRC reestablishment procedure. This may enable to save connectivity interruption, power consumption and signaling overhead, on both the network and the first wireless device.

### Action 203

In this Action 203, the first wireless device 131 sends a first indication to the first network node 111, e.g., the source node, e.g., via the first link 141.

As stated earlier, the first wireless device 131 is served by the first network node 111 and the first cell 121 is served by the second network node 112.

The first indication indicates one or more measurements performed by the first wireless device 131 on the one or more cells 120. With the proviso the first information indicates the first cell 121 lacks support for the first wireless device 131 having the reduced capability, the first wireless device 131 refrains from indicating any measurements performed on the first cell 121 to the first network node 111 in the first indication.

The first indication may be an IE or a report, e.g., a measurement report.

In some embodiments, one of the following two options may apply. According to a first option, with the proviso the first information indicates the first cell 121 lacks support for the first wireless device 131 having the reduced capability, the first wireless device 131 may send any measurements performed on the first cell 121 to the first network node 111 in a different indication than the first indication. The different indication may be a third indication.

According to a second option, with the proviso the first information indicates the first cell 121 lacks support for the first wireless device 131 having the reduced capability, the first wireless device 131 may refrain from indicating any measurements performed on the first cell 121 to the first network node 111 in any indication.

In some embodiments, one of the following may apply. In some embodiments a), i) the first indication may be a first information element (IE) and the different indication may be a different IE, or ii) any indication may be any information element. In some embodiments b), i) the first indication may be a first report and the different indication may be a different report, or ii) any indication may be any report. In some embodiments, the first indication may be sent in a Radio Resource Control (RRC), message.

In one example, when a measurement report may be triggered on the RedCap UE, when the measurement report may be sent to the network, e.g., the first network node 111, the RedCap UE may include only measurements related to the cells that may support the RedCap feature, while it may leave out measurement to cells that may not be able to support RedCap. Even if the legacy network node may not understand whether a specific cell may support RedCap or not, a RedCap UE implemented according to Rel-17 specifications may have this information. Therefore, if the UE is RedCap and it understands a network node is legacy, that its, that it does not support RedCap, then it may refrain from sending a measurement report towards the network node. In that case, the network node may not initiate handover towards it from the legacy network node, as it may not have the measurement reports to indicate that a handover may be needed.

Alternatively, when the measurement report may be sent to the first network node 111, the RedCap UE may include both the measurements related to cell that may support RedCap and those one of cells that may not support RedCap in separate reports, even if both reports may be included in the same message. In this case, the second set of measurements corresponding to the cells which may support RedCap may need to be transmitted so that a legacy cell not supporting RedCap may not use this information when deciding whether and to which cell to trigger a handover, that is, in a backwards compatible way. For example, the information may be provided in an extension to an RRC message which a legacy node may discard, as it may not understand the content.

In some embodiments, the first wireless device 131 may perform at least one of the determining of Action 202 and the sending of this Action 203, with the proviso that an instruction may be received from the first network node 111 instructing the first wireless device 131 to perform the determination.

By sending the first indication to the first network node 111 in this Action 203, and with the proviso that the first information indicates the first cell lacks support for the first wireless device 131 having the reduced capability, the first wireless device 131 refrains from indicating any measurements performed on the first cell 121 to the first network node 111 in the first indication, the first wireless device 131 may be understood to ultimately enable that the first wireless device 131 having the reduced capability, e.g., a RedCap UE, may not be allowed to be handed off to a network node that may not support the reduced capability, e.g., RedCap, feature. This may be understood to prevent that the first wireless device 131 having the reduced capability may operate in a network that may not support the feature, or alternatively, to trigger unnecessarily the RRC reestablishment procedure, thus enabling to save connectivity interruption, power consumption and signaling overhead, on both the network, e.g., the first network node 111, and the first wireless device 131.

### Action 204

In this Action 204, the first wireless device 131 may initiate performing a handover to the first cell 121 based on the sent first indication or the indication different than the first indication.

Initiating may be understood as enabling, beginning, or triggering or performing the handover.

Initiating the performing the handover may be according to one or more messages received from the first network node 111 and/or the second network node 112, based on the sent first indication.

By initiating performing a handover to the first cell 121 based on the sent first indication or the indication different than the first indication in this Action 204, the first wireless device 131 may be enabled to handed over to the first cell 121 with the proviso the first cell 121 may support the first wireless device 131 with the reduced capability and to not be handed over the first cell 121 with the proviso the first cell 121 may lack support for the first wireless device 131 with the reduced capability. This may be understood to prevent that the first wireless device 131, that is, a wireless device with reduced capability, e.g., a RedCap device, operates in a network that may not support the feature, or alternatively, to trigger unnecessarily the RRC reestablishment procedure thus incurring in long connectivity interruption, higher power consumption and higher signaling overhead, on both the network, e.g., the first network node 111, and the first wireless device 131.

Embodiments of a method, performed by the first network node 111, will now be described with reference to the flowchart depicted in FIG. 3. The method is for handling the indication, e.g., the first indication. The first network node 111 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

In some embodiments, the wireless communications network 100 may be a 5G network.

Several embodiments are comprised herein. In some embodiments, all the actions may be performed. In other embodiments, some of the actions may be performed. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. A non-limiting example of the method performed by the first network node 111 is depicted in FIG. 3. In FIG. 3, optional actions are represented with dashed lines.

The detailed description of some of the following corresponds to the same references provided above, in relation to the actions described for the first wireless device 131 and will thus not be repeated here to simplify the description. For example, In particular examples, the first wireless device 131 may be a RedCap UE. The actions may be performed in a different order than that depicted in FIG. 3.

### Action 301

In this Action 301, the first network node 111 may select the second network node 112.

The selecting may be of a network node to perform handover of the first wireless device 131. That is, the selecting may be of a target network node for the first wireless device 131.

### Action 302

In some embodiments, in this Action 302, the first network node 111 may send a message. The sending of the message in this Action 302 may be to the second network node 112. The message may inquire if the second network node 112 may support or not the service to the first wireless device 131 having the reduced capability.

The sending in this Action 302 may be performed, e.g., via the third link 143.

In an example, upon receiving the measurement report from the first wireless device 131, the first network node 111 may send a signaling to the cell IDs, that is, the potential target network nodes, listed in the measurement report, that is, in the first indication, in order to inquire whether they may support RedCap or not. After receiving a reply from the potential target network nodes, the source network node may decide to choose a target network node that may support RedCap.

Alternatively, in another example, the first network node 111 may decide to select a target network node such as the second network node 112 in accordance with Action 301 first and then, send, according to this Action 302, a signaling to the selected target network node such as the second network node 112 to check on whether this selected target network node may support RedCap or not.

In one example, the signaling sent by the first wireless device 131 to one or multiple target nodes such as the second network node 112 may be a new standalone signaling or it may be included in some existing message, e.g., handover request message or handover preparation information message, exchanged between the first network node 111 and a target network node such as the second network node 112. Also, the signaling sent by the first wireless device 131 to one or multiple target nodes such as the second network node 112 may be sent via inter-node RRC messages or via X2/Xn messages.

By the first network node 111 sending the message to the second network node 112 inquiring if the second network node 112 may support or not the service to the first wireless device 131 having the reduced capability in this Action 302, the first network node 111 may then be enabled to obtain a response on whether the second network node 112 may support or not the service to the first wireless device 131 having the reduced capability, and inform the first wireless device 131 accordingly. This may in turn ultimately enable to prevent that the first wireless device 131 may be handed over to a target network node that may not support the reduced capability, or alternatively, to trigger unnecessarily the RRC reestablishment procedure. Hence, the first network node 111 may enable to save connectivity interruption, power consumption and signaling overhead, on both the network and the first wireless device 131.

### Action 303

In some embodiments, in this Action 303, the first network node 111 may obtain the first information from the second network node 112 serving the first cell 121.

The obtaining in this Action 303 may be performed, e.g., via the third link 143. In some embodiments, the first information may be obtained in the broadcast from the first cell 121.

The obtaining in Action 303 of the first information may be in response to the sent message in Action 302.

As stated earlier in an example, the first network node 111 may decide to select a target network node such as the second network node 112 in accordance with Action 301 first and then, send, according to this Action 302, a signaling to the selected target network node such as the second network node 112 to check on whether this selected target network node may support RedCap or not. In such a case, if the target node replies that it supports RedCap, the first network node 111 may proceed to execute the handover procedure. However, if the selected target network node replies that it does not support RedCap, then the first network node 111 may decide to either select a new target network node and send a signaling to discover whether this new selected target network node may support RedCap or either abort the handover procedure and release the UE to RRC_IDLE or RRC_INACTIVE.

In some embodiments, the first network node 111 may determine the first cell 121 lacks support for the service to the first wireless device 131 having the reduced capability based on the first information lacking the indicator explicitly indicating support for the reduced capability is provided.

In some embodiments, the first information may be obtained in at least one of: i) previous operations, ii) inter-node signalling with the second network node 112, iii) X2/Xn signaling, iv) OAM functions, v) previous handovers, vi) SON, vii) a MDT network, and viii) an ANR.

In some embodiments, the first information may lack an indicator explicitly indicating support for the reduced capability is provided.

By the first network node 111 obtaining the first information from second network node 112 in this Action 303, the first network node 111 may then be enabled to know whether the second network node 112 may support or not the service to the first wireless device 131 having the reduced capability, and inform the first wireless device 131 accordingly. This may in turn ultimately enable to prevent that the first wireless device 131 may be handed over to a target network node that may not support the reduced capability, or alternatively, to trigger unnecessarily the RRC reestablishment procedure. Hence, the first network node 111 may enable to save connectivity interruption, power consumption and signaling overhead, on both the network and the first wireless device 131.

### Action 304

In this Action 304, the first network node 111 sends, to the first wireless device 131, the information, e.g., the first information.

The sent first information may be the obtained first information in Action 303.

The first information indicates whether or not the first cell 121 supports service to the first wireless device 131 having the reduced capability with respect to the group of second wireless devices 132.

As stated earlier, the first network node 111 serves the first wireless device 131 and the first cell 121 is served by the second network node 112.

The sending in this Action 304 may be performed, e.g., via the first link 141.

In some embodiments, the first information may be the configuration from the first network node 111. The configuration may configure the first wireless device 131 to perform measurements on frequencies where cells supporting service to wireless devices with reduced capability may operate.

The configuration, e.g., a measurement configuration, may comprise the second indication, e.g., the list, about which cell IDs may be those of cells that already support redcap.

In some embodiments, the first information may be obtained from the first cell 121, e.g., in a broadcast from the first cell 121.

In some embodiments, at least one of the following may apply: a) the first information may be comprised in MIB, e.g., one or more MIBs; b) the first information may be comprised in SIB, e.g., one or more SIBs; c) the first information may be comprised in SIB3/4, e.g., one or more SIBs3/4; d) the first network node 111 may determine the first cell 121 lacks support for the service to the first wireless device 131 having the reduced capability based on the first information lacking the indicator explicitly indicating support for the reduced capability is provided; e) the first information may be obtained in at least one of: i) previous operations, ii) inter-node signalling with the second network node 112, iii) X2/Xn signaling, iv) OAM functions, v) previous handovers, vi) SON, vii) a MDT network, and viii) an ANR; and f) the first wireless device 131 may be a RedCap UE.

By the first network node 111 sending the first information to the first wireless device 131 in this Action 304, the first network node 111 may be understood to enable the first wireless device 131 to determine, whether or not the first cell 121 may support service to the first wireless device 131 having the reduced capability. This may in turn enable the first wireless device 131 to know whether or not to indicate any measurements performed on the first cell 121 to the first network node 111 in the first indication. By the first network node 111 receiving the first indication indicating the one or more measurements performed by the first wireless device 131 on the one or more cells 120, wherein with the proviso the first information indicates the first cell 121 lacks support for the first wireless device 131 having the reduced capability, the first wireless device 131 refrains from indicating any measurements performed on the first cell 121 to the first network node 111 in the first indication, the first network node 111 may be enabled to refrain from handing off the first wireless device 131 to a network node that may not support the reduced capability, e.g., RedCap, feature. This may be understood to prevent that the first wireless device 131 having the reduced capability may operate in a network that may not support the feature, or alternatively, to trigger unnecessarily the RRC reestablishment procedure, thus enabling to save connectivity interruption, power consumption and signaling overhead, on both the network, e.g, the first network node 111, and the first wireless device 131.

### Action 305

In this Action 305, the first network node 111 receives the first indication.

The receiving in this Action 305 is from the first wireless device 131.

The first indication indicates the one or more measurements performed by the first wireless device 131 on the one or more cells 120.

With the proviso the first information indicates the first cell 121 lacks support for the first wireless device 131 having the reduced capability, the first wireless device 131 refrains from indicating any measurements performed on the first cell 121 to the first network node 111 in the first indication. Consequently, with the proviso the first information indicates the first cell 121 lacks support for the first wireless device 131 having the reduced capability, the first indication lacks any measurements performed on the first cell 121.

In some embodiments, one of the following may apply. In some embodiments, with the proviso the first information indicates the first cell 121 lacks support for the first wireless device 131 having the reduced capability, the first network node 111 may receive any measurements performed by the first wireless device 131 on the first cell 121 in the different indication than the first indication.

The different indication may be the third indication.

In some embodiments, with the proviso the first information indicates the first cell 121 lacks support for the first wireless device 131 having the reduced capability, the first wireless device 131 may refrain from indicating any measurements performed on the first cell 121 to the first network node 111 in any indication. Consequently, with the proviso the first information indicates the first cell 121 lacks support for the first wireless device 131 having the reduced capability, the first indication lacks any measurements performed on the first cell 121.

In some embodiments, one of the following may apply. In some embodiments a), i) the first indication may be the first IE and the different indication may be the different IE, or ii) any indication may be any IE. In some embodiments b), i) the first indication may be the first report and the different indication may be the different report, or ii) any indication may be any report.

In some embodiments, the first indication may be received in the RRC message.

By the first network node 111 the first indication from the first wireless device 131 in this Action 305, and with the proviso the first information indicates the first cell 121 lacks support for the first wireless device 131 having the reduced capability, the first wireless device 131 refrains from indicating any measurements performed on the first cell 12 to the first network node 111 in the first indication, the first network node 111 may be understood to be enabled to avoid that that the first wireless device 131 having the reduced capability, e.g., a RedCap UE, may be handed off to a network node that may not support the reduced capability, e.g., RedCap, feature. This may be understood to prevent that the first wireless device 131 having the reduced capability may operate in a network that may not support the feature, or alternatively, to trigger unnecessarily the RRC reestablishment procedure, thus enabling to save connectivity interruption, power consumption and signaling overhead, on both the network, e.g., the first network node 111, and the first wireless device 131.

### Action 306

In this Action 306, the first network node 111 may initiate performing the handover. The handover may be of the first wireless device 131 to the first cell 121 based on the received first indication or the indication different than the first indication.

As stated earlier in an example, the first network node 111 may decide to select a target network node such as the second network node 112 in accordance with Action 301 first and then, send, according to this Action 302, a signaling to the selected target network node, such as the second network node 112, to check on whether this selected target network node may support the reduced capability, e.g., RedCap, or not. In such a case, if the second network node 112 replies that it supports reduced capability, the first network node 111 may proceed to execute the handover procedure in this Action 306. However, if the selected second network node 112 replies that it does not support reduced capability, then the first network node 111 may decide to either select a new target network node and send a signaling to discover whether this new selected target network node may support RedCap or either abort the handover procedure and release the UE to RRC_IDLE or RRC_INACTIVE.

By the first network node 111 initiating performing the handover in this Action 306, the first network node 111 based on the received first indication or the indication different than the first indication, the first network node 111 may be enabled to refrain from handing off the first wireless device 131 to the second network node 112 if the second network node 112 does not support the reduced capability, e.g., RedCap, feature, and to only hand off the first wireless device 131 to the second network node 112 if the second network node 112 supports the reduced capability, e.g., RedCap, feature. This may be understood to prevent that the first wireless device 131 having the reduced capability may operate in a network that may not support the feature, or alternatively, to trigger unnecessarily the RRC reestablishment procedure, thus enabling to save connectivity interruption, power consumption and signaling overhead, on both the network, e.g, the first network node 111, and the first wireless device 131.

In some related examples not specifically depicted in FIG. 3, the first network node 111 may perform any of Actions 301-304 and 306.

Certain embodiments disclosed herein may provide one or more of the following technical advantage(s), which may be summarized as follows. Embodiments herein, may be understood to enable that a RedCap UE is not allowed to be handed off to a network node that may not support the RedCap feature. This may be understood to prevent a RedCap UE to operate in a network that may not support the feature, or alternatively, to trigger unnecessarily the RRC reestablishment procedure thus incurring in long connectivity interruption, higher power consumption and higher signaling overhead, on both the network and the UE.

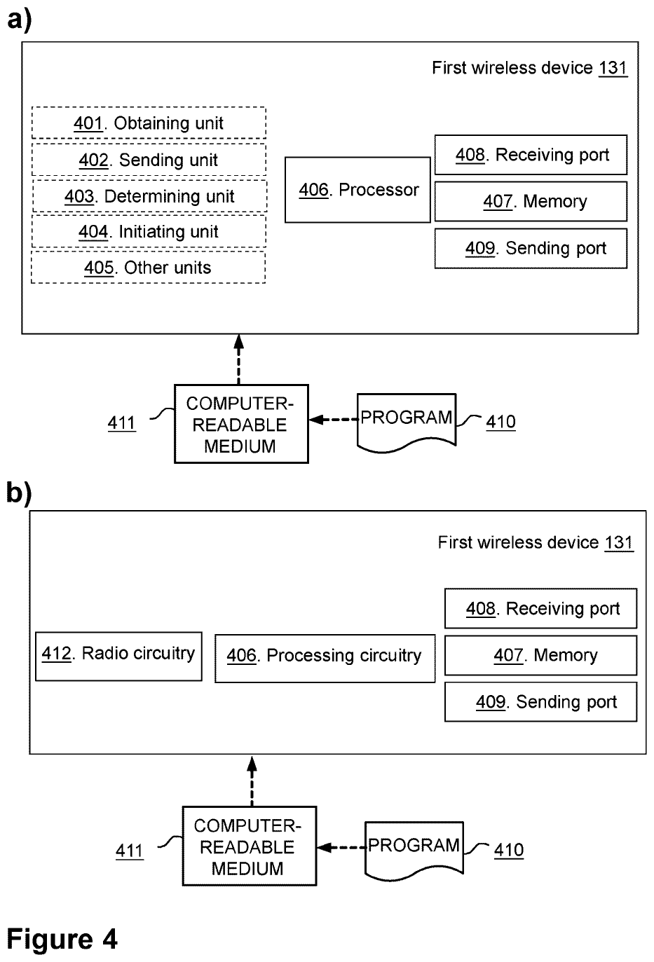

FIG. 4 depicts two different examples in panels a) and b), respectively, of the arrangement that the first wireless device 131 may comprise to perform the method actions described above in relation to FIG. 2. In some embodiments, the first wireless device 131 may comprise the following arrangement depicted in FIG. 4a. The first wireless device 131 may be understood to be for handling the indication. The first wireless device 131 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first wireless device 131 and will thus not be repeated here to simplify the description. For example, the first wireless device 131 may be configured to be a RedCap UE.

In FIG. 4, optional units are indicated with dashed boxes.

The first wireless device 131 is configured to perform the obtaining in Action 201, e.g. by means of an obtaining unit 401 within the first wireless device 131, configured to obtain the first information configured to indicate whether or not the first cell 121 is configured to support service to a the first wireless device 131 being configured to have the reduced capability with respect to the group of second wireless devices 132.

The first wireless device 131 is also configured to perform the sending in Action 203, e.g. by means of a sending unit 402 within the first wireless device 131, configured to send the first indication to the first network node 111. The first wireless device 131 is configured to be served by the first network node 111 and the first cell 121 is configured to be served by the second network node 112. The first indication is configured to indicate the one or more measurements configured to be performed by the first wireless device 131 on the one or more cells 120. With the proviso the first information is configured to indicate the first cell 121 lacks support for the first wireless device 131 configured to have the reduced capability, the first wireless device 131 is configured to refrain from indicating any measurements configured to be performed on the first cell 121 to the first network node 111 in the first indication.

In some embodiments, one of the following options may apply. According to a first option, with the proviso the first information is configured to indicate the first cell 121 lacks support for the first wireless device 131 configured to have the reduced capability, the first wireless device 131 may be configured to send any measurements configured to be performed on the first cell 121 to the first network node 111 in the different indication than the first indication. According to a second option, with the proviso the first information is configured to indicate the first cell 121 lacks support for the first wireless device 131 configured to have the reduced capability, the first wireless device 131 may be configured to refrain from indicating any measurements performed on the first cell 121 to the first network node 111 in any indication.

In some embodiments, one of the following may apply. In some embodiments a), i) the first indication may be configured to be the first information element and the different indication may be configured to be the different information element, or ii) any indication may be configured to be any information element. In some embodiments b), the first indication may be configured to be the first report and the different indication may be configured to be the different report, or any indication may be configured to be any report. In some embodiments, c) the first indication may be configured to be sent in the RRC message.

In some embodiments, the first information may be configured to be the configuration from the first network node 111.

In some embodiments, the configuration may be configured to configure the first wireless device 131 to perform measurements on frequencies where cells supporting service to wireless devices with reduced capability may be configured to operate.

In some embodiments, the first information may be configured to be obtained in the broadcast from the first cell 121.

In some embodiments, the first wireless device 131 may be configured to perform the determining in Action 202, e.g. by means of a determining unit 403 within the first wireless device 131, configured to determine whether or not the first cell 121 may support service to the first wireless device 131 configured to have the reduced capability with respect to the group of second wireless devices 132, based on the first information configured to be obtained.

In some embodiments, the first wireless device 131 may be configured to perform at least one of the determining and the sending, with the proviso that the instruction may be received from the first network node 111 instructing the first wireless device 131 to perform the determination.

In some embodiments, at least one of the following options may apply. According to a first option, the first information may be configured to be comprised in MIB. According to a second option, the first information may be configured to be comprised in SIB. According to a third option, the first information may be configured to be comprised in SIB3/4. According to a fourth option, the first wireless device 131 may be configured to determine the first cell 121 lacks support for the service to the first wireless device 131 configured to have the reduced capability based on the first information being configured to lack the indicator configured to explicitly indicate support for the reduced capability is provided. According to a fifth option, the first wireless device 131 may be configured to be a RedCap UE.

In some embodiments, the first wireless device 131 may be further configured to perform the initiating of Action 204, e.g. by means of an initiating unit 404 within the first wireless device 131, configured to initiate performing the handover to the first cell 121 based on the first indication or the indication different than the first indication configured to be sent.

Other units 405 may be comprised in the first wireless device 131.

The embodiments herein in the first wireless device 131 may be implemented through one or more processors, such as a processor 406 in the first wireless device 131 depicted in FIG. 4a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first wireless device 131. One such carrier may be in the form of a CD ROM disc. It is however feasible with other data carriers such as a memory stick. The computer program code may furthermore be provided as pure program code on a server and downloaded to the first wireless device 131.

The first wireless device 131 may further comprise a memory 407 comprising one or more memory units. The memory 407 is arranged to be used to store obtained information, store data, configurations, schedulings, and applications etc. to perform the methods herein when being executed in the first wireless device 131.

In some embodiments, the first wireless device 131 may receive information from, e.g., the first network node 111, the second network node 112 or another network node or device through a receiving port 408. In some embodiments, the receiving port 408 may be, for example, connected to one or more antennas in first wireless device 131. In other embodiments, the first wireless device 131 may receive information from another structure in the wireless communications network 100 through the receiving port 408. Since the receiving port 408 may be in communication with the processor 406, the receiving port 408 may then send the received information to the processor 406. The receiving port 408 may also be configured to receive other information.

The processor 406 in the first wireless device 131 may be further configured to transmit or send information to e.g., the first network node 111, the second network node 112, another network node or device, or another structure in the wireless communications network 100, through a sending port 409, which may be in communication with the processor 406, and the memory 407.

Those skilled in the art will also appreciate that the different units 401-405 described above may refer to a combination of analog and digital modules, and/or one or more processors configured with software and/or firmware, e.g., stored in memory, that, when executed by the one or more processors such as the processor 406, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 401-405 described above may be implemented as one or more applications running on one or more processors such as the processor 406.

Thus, the methods according to the embodiments described herein for the first wireless device 131 may be respectively implemented by means of a computer program 410 product, comprising instructions, i.e., software code portions, which, when executed on at least one processor 406, cause the at least one processor 406 to carry out the actions described herein, as performed by the first wireless device 131. The computer program 410 product may be stored on a computer-readable storage medium 411. The computer-readable storage medium 411, having stored thereon the computer program 410, may comprise instructions which, when executed on at least one processor 406, cause the at least one processor 406 to carry out the actions described herein, as performed by the first wireless device 131. In some embodiments, the computer-readable storage medium 411 may be a non-transitory computer-readable storage medium, such as a CD ROM disc, or a memory stick. In other embodiments, the computer program 410 product may be stored on a carrier containing the computer program 410 just described, wherein the carrier is one of an electronic signal, optical signal, radio signal, or the computer-readable storage medium 411, as described above.

The first wireless device 131 may comprise a communication interface configured to facilitate communications between the first wireless device 131 and other nodes or devices, e.g., the first network node 111, the second network node 112, another network node or device, or another structure in the wireless communications network 100. The interface may, for example, include a transceiver configured to transmit and receive radio signals over an air interface in accordance with a suitable standard.

In other embodiments, the first wireless device 131 may comprise the following arrangement depicted in FIG. 4b. The first wireless device 131 may comprise a processing circuitry 406, e.g., one or more processors such as the processor 406, in the first wireless device 131 and the memory 407. The first wireless device 131 may also comprise a radio circuitry 412, which may comprise e.g., the receiving port 408 and the sending port 409. The processing circuitry 412 may be configured to, or operable to, perform the method actions according to FIG. 2, in a similar manner as that described in relation to FIG. 4a. The radio circuitry 412 may be configured to set up and maintain at least a wireless connection with the first network node 111, the second network node 112, another network node or device, or another structure in the wireless communications network 100. Circuitry may be understood herein as a hardware component.

Hence, embodiments herein also relate to the first wireless device 131 comprising the processing circuitry 406 and the memory 407, said memory 407 containing instructions executable by said processing circuitry 406, whereby the first wireless device 131 is operative to perform the actions described herein in relation to the first wireless device 131, e.g., in FIG. 2.

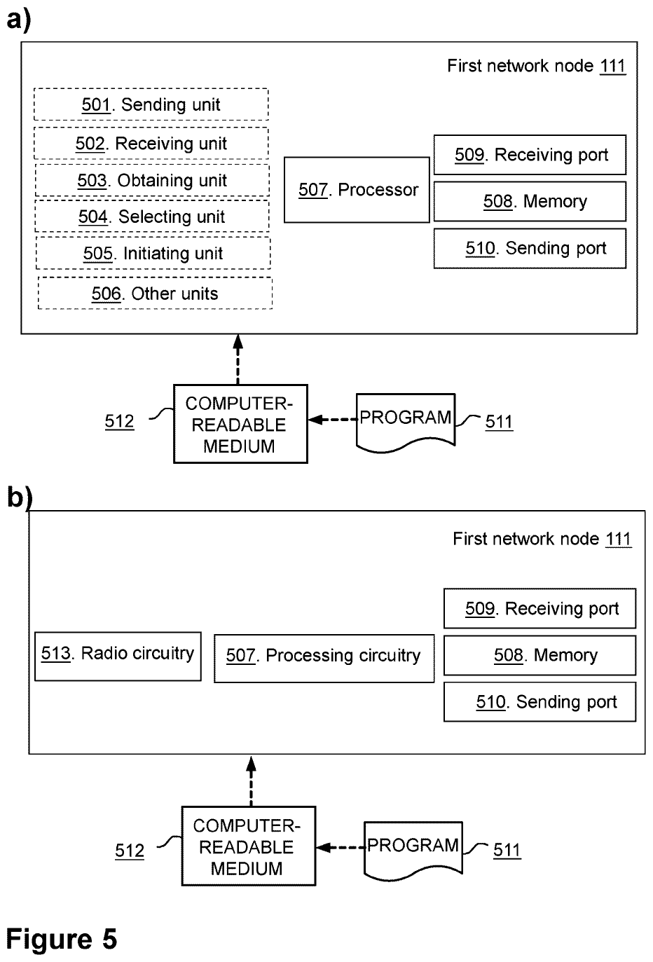

FIG. 5 depicts two different examples in panels a) and b), respectively, of the arrangement that the first network node 111 may comprise to perform the method actions described above in relation to FIG. 3. In some embodiments, the first network node 111 may comprise the following arrangement depicted in FIG. 5a. The first network node 111 may be understood to be for handling the indication. The first network node 111 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first wireless device 131, and will thus not be repeated here. For example, the first wireless device 131 may be configured to be a RedCap UE.

In FIG. 5, optional modules are indicated with dashed boxes.

The first network node 111 is configured to perform the sending in Action 304, e.g. by means of a sending unit 501 within the first network node 111, configured to send, to the first wireless device 131, the first information configured to indicate whether or not the first cell 121 is configured to support service to the first wireless device 131 configured to have the reduced capability with respect to the group of second wireless devices 132. The first network node 111 is configured to serve the first wireless device 131 and the first cell 121 is configured to be served by the second network node 112.

The first network node 111 is also configured to perform the receiving of Action 305, e.g. by means of a receiving unit 502 within the first network node 111, configured to receive the first indication from the first wireless device 131. The first indication is configured to indicate the one or more measurements configured to be performed by the first wireless device 131 on the one or more cells 120, wherein, with the proviso the first information is configured to indicate the first cell 121 lacks support for the first wireless device 131 configured to have the reduced capability, the first wireless device 131 is configured to refrain from indicating any measurements performed on the first cell 121 to the first network node 111 in the first indication.

In some embodiments, one of the following options may apply. According to a first option, with the proviso the first information is configured to indicate the first cell 121 lacks support for the first wireless device 131 configured to have the reduced capability, the first network node 111 may be configured to receive any measurements configured to be performed by the first wireless device 131 on the first cell 121 in the different indication than the first indication. According to a second option, with the proviso the first information is configured to indicate the first cell 121 lacks support for the first wireless device 131 configured to have the reduced capability, first wireless device 131 may be configured to refrain from indicating any measurements performed on the first cell 121 to the first network node 111 in any indication.

In some embodiments, one of the following may apply. In some embodiments a), i) the first indication may be configured to be the first information element and the different indication may be configured to be the different information element, or ii) any indication may be configured to be any information element. In some embodiments b), the first indication may be configured to be the first report and the different indication may be configured to be the different report, or ii) any indication may be configured to be any report. In some embodiments, c) the first indication may be configured to be received in the RRC message.

In some embodiments, the first information may be configured to be the configuration from the first network node 111.

In some embodiments, the configuration may be configured to configure the first wireless device 131 to perform measurements on frequencies where cells configured to support service to wireless devices with reduced capability may be configured to operate.

In some embodiments, the first network node 111 may be configured to perform the obtaining of Action 303, e.g. by means of an obtaining unit 503 within the first network node 111, configured to obtain the first information from the second network node 112 configured to serve the first cell 121. The first information configured to be sent may be the first information configured to be obtained.

In some embodiments, the first information may be configured to be obtained in the broadcast from the first cell 121.

In some embodiments, at least one of the following options may apply. According to a first option, the first information may be configured to be comprised in MIB. According to a second option, the first information may be configured to be comprised in SIB. According to a third option, the first information may be configured to be comprised in SIB3/4. According to a fourth option, the first network node 111 may be configured to determine the first cell 121 lacks support for the service to the first wireless device 131 configured to have the reduced capability based on the first information being configured to lack the indicator configured to explicitly indicate support for the reduced capability is provided. According to a fifth option, the first information may be configured to be obtained in at least one of: i) the previous operations, ii) the inter-node signalling with the second network node 112, iii) the X2/Xn signaling, iv) the OAM functions, v) the previous handovers, vi) the SON, vii) the MDT network, and viii) the ANR. According to a sixth option, the first wireless device 131 may be configured to be a RedCap UE.

In some embodiments, the first network node 111 may be configured to perform the selecting in Action 301, e.g. by means of a selecting unit 504 within the first network node 111, configured to select the second network node 112.

The first network node 111 may be configured to perform the sending in Action 302, e.g. by means of the sending unit 501 within the first network node 111, configured to send the message to the second network node 112 configured to inquire if the second network node 112 supports or not the service to the first wireless device 131 configured to have the reduced capability. The obtaining of the first information may be in response to the message configured to be sent.

In some embodiments, the first network node 111 may be configured to perform the initiating in Action 306, e.g. by means of an initiating unit 505 within the first network node 111, configured to initiate performing the handover of the first wireless device 131 to the first cell 121 based on the first indication configured to be received or the indication different than the first indication.

Other units 506 may be comprised in the first network node 111.

The embodiments herein in the first network node 111 may be implemented through one or more processors, such as a processor 507 in the first network node 111 depicted in FIG. 5a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 508 comprising one or more memory units. The memory 508 is arranged to be used to store obtained information, store data, configurations, schedulings, and applications etc. to perform the methods herein when being executed in the first network node 111.

In some embodiments, the first network node 111 may receive information from, e.g., the first wireless device 131, the second network node 112, or another node or device through a receiving port 509. In some embodiments, the receiving port 509 may be, for example, connected to one or more antennas in first network node 111. In other embodiments, the first network node 111 may receive information from another structure in the wireless communications network 100 through the receiving port 509. Since the receiving port 509 may be in communication with the processor 507, the receiving port 509 may then send the received information to the processor 507. The receiving port 509 may also be configured to receive other information.

The processor 507 in the first network node 111 may be further configured to transmit or send information to e.g., the first wireless device 131, the second network node 112, another node or device, or another structure in the wireless communications network 100, through a sending port 510, which may be in communication with the processor 507, and the memory 508.

Those skilled in the art will also appreciate that the different units 501-506 described above may refer to a combination of analog and digital modules, and/or one or more processors configured with software and/or firmware, e.g., stored in memory, that, when executed by the one or more processors such as the processor 507, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 501-506 described above may be implemented as one or more applications running on one or more processors such as the processor 507.

Thus, the methods according to the embodiments described herein for the first network node 111 may be respectively implemented by means of a computer program 511 product, comprising instructions, i.e., software code portions, which, when executed on at least one processor 507, cause the at least one processor 507 to carry out the actions described herein, as performed by the first network node 111. The computer program 511 product may be stored on a computer-readable storage medium 512. The computer-readable storage medium 512, having stored thereon the computer program 511, may comprise instructions which, when executed on at least one processor 507, cause the at least one processor 507 to carry out the actions described herein, as performed by the first network node 111. In some embodiments, the computer-readable storage medium 512 may be a non-transitory computer-readable storage medium, such as a CD ROM disc, or a memory stick. In other embodiments, the computer program 511 product may be stored on a carrier containing the computer program 511 just described, wherein the carrier is one of an electronic signal, optical signal, radio signal, or the computer-readable storage medium 512, as described above.

The first network node 111 may comprise a communication interface configured to facilitate communications between the first network node 111 and other nodes or devices, e.g., the first wireless device 131, the second network node 112, another node or device, or another structure in the wireless communications network 100. The interface may, for example, include a transceiver configured to transmit and receive radio signals over an air interface in accordance with a suitable standard.

In other embodiments, the first network node 111 may comprise the following arrangement depicted in FIG. 5b. The first network node 111 may comprise a processing circuitry 507, e.g., one or more processors such as the processor 507, in the first network node 111 and the memory 508. The first network node 111 may also comprise a radio circuitry 513, which may comprise e.g., the receiving port 509 and the sending port 510. The processing circuitry 507 may be configured to, or operable to, perform the method actions according to FIG. 3, in a similar manner as that described in relation to FIG. 5a. The radio circuitry 513 may be configured to set up and maintain at least a wireless connection with the first wireless device 131, the second network node 112, another node or device, or another structure in the wireless communications network 100. Circuitry may be understood herein as a hardware component.

Hence, embodiments herein also relate to the first network node 111 comprising the processing circuitry 507 and the memory 508, said memory 508 containing instructions executable by said processing circuitry 507, whereby the first network node 111 is operative to perform the actions described herein in relation to the first network node 111, e.g., in FIG. 3.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of: ” followed by a list of alternatives separated by commas, and wherein the last alternative is preceded by the “or” term.

### SELECTED EXAMPLES

Example 1. A method performed by a first wireless device (131), the method being for handling an indication, the first wireless device (131) operating in a wireless communications network (100), and the method comprising:
obtaining (201) first information indicating whether or not a first cell (121) supports service to a first wireless device (131) having a reduced capability with respect to a group of second wireless devices (132), and
sending (203) a first indication to a first network node (111), wherein the first wireless device (131) is served by the first network node (111) and the first cell (121) is served by a second network node (112), wherein the first indication indicates one or more measurements performed by the first wireless device (131) on one or more cells (120), wherein, with the proviso the first information indicates the first cell (121) lacks support for the first wireless device (131) having the reduced capability, the first wireless device (131) refrains from indicating any measurements performed on the first cell (121) to the first network node (111) in the first indication.

Example 2. The method according to example 1, wherein one of:
with the proviso the first information indicates the first cell (121) lacks support for the first wireless device (131) having the reduced capability, the first wireless device (131) sends any measurements performed on the first cell (121) to the first network node (111) in a different indication than the first indication, and
with the proviso the first information indicates the first cell (121) lacks support for the first wireless device (131) having the reduced capability, the first wireless device (131) refrains from indicating any measurements performed on the first cell (121) to the first network node (111) in any indication.

Example 3. The method according to example 2, wherein one of:
a) the first indication is a first information element and the different indication is a different information element, or any indication is any information element,
b) the first indication is a first report and the different indication is a different report, or any indication is any report, and
the first indication is sent in a Radio Resource Control, RRC, message.

Example 4. The method according to any of examples 1-3, wherein the first information is a configuration from the first network node (111).

Example 5. The method according to example 4, wherein the configuration configures the first wireless device (131) to perform measurements on frequencies where cells supporting service to wireless devices with reduced capability operate.

Example 6. The method according to any of examples 1-3, wherein the first information is obtained in a broadcast from the first cell (121).

Example 7. The method according to any of examples 1-4, further comprising:
determining (202) whether or not the first cell (121) supports service to the first wireless device (131) having the reduced capability with respect to the group of second wireless devices (132), based on the obtained first information.

Example 8. The method according to example 7, wherein the first wireless device (131) performs at least one of the determining (202) and the sending (203), with the proviso that an instruction is received from the first network node (111) instructing the first wireless device (131) to perform the determination,

Example 9. The method according to any of examples 7-8, wherein at least one of:
the first information is comprised in Master Information Block, MIB,
the first information is comprised in System Information Block, SIB,
the first information is comprised in SIB3/4, and
wherein the first wireless device (131) determines the first cell (121) lacks support for the service to the first wireless device (131) having the reduced capability based on the first information lacking an indicator explicitly indicating support for the reduced capability is provided.

Example 10. The method according to example 2 any of examples 3-9, further comprising:
initiating (204) performing a handover to the first cell (121) based on the sent first indication or the indication different than the first indication.

Example 11. A method performed by a first network node (111), the method being for handling an indication, first network node (111) operating in a wireless communications network (100), and the method comprising:
sending (304), to a first wireless device (131), first information indicating whether or not a first cell (121) supports service to the first wireless device (131) having a reduced capability with respect to a group of second wireless devices (132), wherein the first network node (111) serves the first wireless device (131) and the first cell (121) is served by a second network node (112), and
receiving (305) a first indication from the first wireless device (131), the first indication indicating one or more measurements performed by the first wireless device (131) on one or more cells (120), wherein, with the proviso the first information indicates the first cell (121) lacks support for the first wireless device (131) having the reduced capability, the first wireless device (131) refrains from indicating any measurements performed on the first cell (121) to the first network node (111) in the first indication.

Example 12. The method according to example 11, wherein one of:
with the proviso the first information indicates the first cell (121) lacks support for the first wireless device (131) having the reduced capability, the first network node (111) receives any measurements performed by the first wireless device (131) on the first cell (121) in a different indication than the first indication, and
with the proviso the first information indicates the first cell (121) lacks support for the first wireless device (131) having the reduced capability, the first wireless device (131) refrains from indicating any measurements performed on the first cell (121) to the first network node (111) in any indication.

Example 13. The method according to example 12, wherein one of:
a) the first indication is a first information element and the different indication is a different information element, or any indication is any information element,
b) the first indication is a first report and the different indication is a different report, or any indication is any report, and
the first indication is received in a Radio Resource Control, RRC, message.

Example 14. The method according to any of examples 11-13, wherein the first information is a configuration from the first network node (111).

Example 15. The method according to any example 14, wherein the configuration configures the first wireless device (131) to perform measurements on frequencies where cells supporting service to wireless devices with reduced capability operate.

Example 16. The method according to any of examples 11-15, further comprising:
obtaining (303) the first information from a second network node (112) serving the first cell (121), and wherein the sent first information is the obtained first information.

Example 17. The method according to example 16, wherein the first information is obtained in a broadcast from the first cell (121).

Example 18. The method according to any of examples 16-17, wherein at least one of:
the first information is comprised in Master Information Block, MIB,
the first information is comprised in System Information Block, SIB,
the first information is comprised in SIB3/4,
wherein the first network node (111) determines the first cell (121) lacks support for the service to the first wireless device (131) having the reduced capability based on the first information lacking an indicator explicitly indicating support for the reduced capability is provided;
the first information is obtained in at least one of:
   i. previous operations,
   ii. inter-node signalling with the second network node (112)
   iii. X2/Xn signaling,
   iv. OAM functions,
   v. previous handovers,
   vi. SON,
   vii. an MDT network, and
   viii. an ANR.

Example 19. The method according to any of examples 16-18, further comprising:
selecting (301) the second network node (112), and
sending (302) a message to the second network node (112) inquiring if the second network node (112) support or not the service to the first wireless device (131) having the reduced capability, and wherein the obtaining (303) of the first information is in response to the sent message.

Example 20. The method according to example 12 and any of examples 13-19, further comprising:
initiating (306) performing a handover of the first wireless device (131) to the first cell (121) based on the received first indication or the indication different than the first indication.

### Further Extensions and Variations

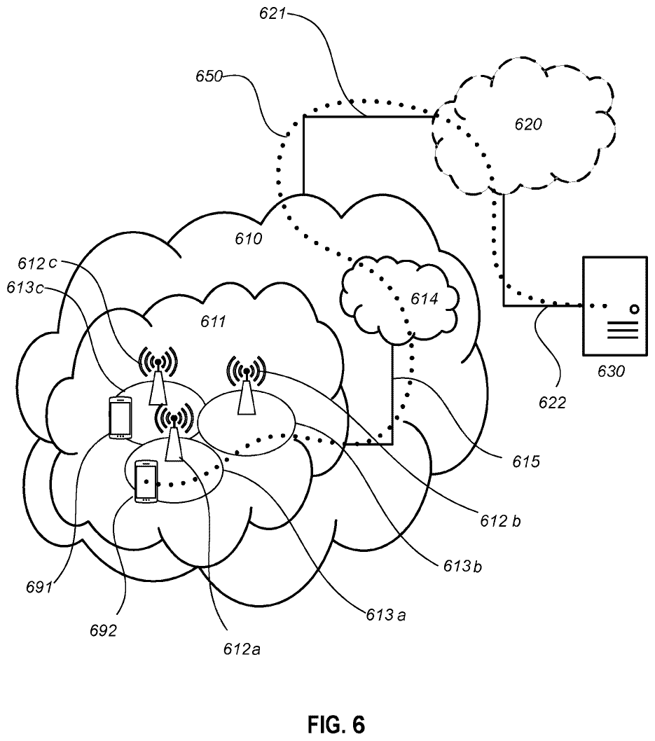

FIG. 6: Telecommunication Network Connected via an Intermediate Network to a Host Computer in Accordance with Some Embodiments

With reference to FIG. 6, in accordance with an embodiment, a communication system includes telecommunication network 610 such as the wireless communications network 100, for example, a 3GPP-type cellular network, which comprises access network 611, such as a radio access network, and core network 614. Access network 611 comprises a plurality of network nodes such as the first network node 111. For example, base stations 612a, 612b, 612c, such as NBs, eNBs, gNBs or other types of wireless access points, each defining a corresponding coverage area 613a, 613b, 613c. Each base station 612a, 612b, 612c is connectable to core network 614 over a wired or wireless connection 615. A plurality of user equipments, such as the first wireless device 131 are comprised in the wireless communications network 100. In FIG. 6, a first UE 691 located in coverage area 613c is configured to wirelessly connect to, or be paged by, the corresponding base station 612c. A second UE 692 in coverage area 613a is wirelessly connectable to the corresponding base station 612a. While a plurality of UEs 691, 692 are illustrated in this example, the disclosed embodiments are equally applicable to a situation where a sole UE is in the coverage area or where a sole UE is connecting to the corresponding base station 612. Any of the UEs 691, 692 are examples of the first wireless device 131.

Telecommunication network 610 is itself connected to host computer 630, which may be embodied in the hardware and/or software of a standalone server, a cloud-implemented server, a distributed server or as processing resources in a server farm. Host computer 630 may be under the ownership or control of a service provider, or may be operated by the service provider or on behalf of the service provider. Connections 621 and 622 between telecommunication network 610 and host computer 630 may extend directly from core network 614 to host computer 630 or may go via an optional intermediate network 620. Intermediate network 620 may be one of, or a combination of more than one of, a public, private or hosted network; intermediate network 620, if any, may be a backbone network or the Internet; in particular, intermediate network 620 may comprise two or more sub-networks (not shown).

The communication system of FIG. 6 as a whole enables connectivity between the connected UEs 691, 692 and host computer 630. The connectivity may be described as an over-the-top (OTT) connection 650. Host computer 630 and the connected UEs 691, 692 are configured to communicate data and/or signaling via OTT connection 650, using access network 611, core network 614, any intermediate network 620 and possible further infrastructure (not shown) as intermediaries. OTT connection 650 may be transparent in the sense that the participating communication devices through which OTT connection 650 passes are unaware of routing of uplink and downlink communications. For example, base station 612 may not or need not be informed about the past routing of an incoming downlink communication with data originating from host computer 630 to be forwarded (e.g., handed over) to a connected UE 691. Similarly, base station 612 need not be aware of the future routing of an outgoing uplink communication originating from the UE 691 towards the host computer 630.

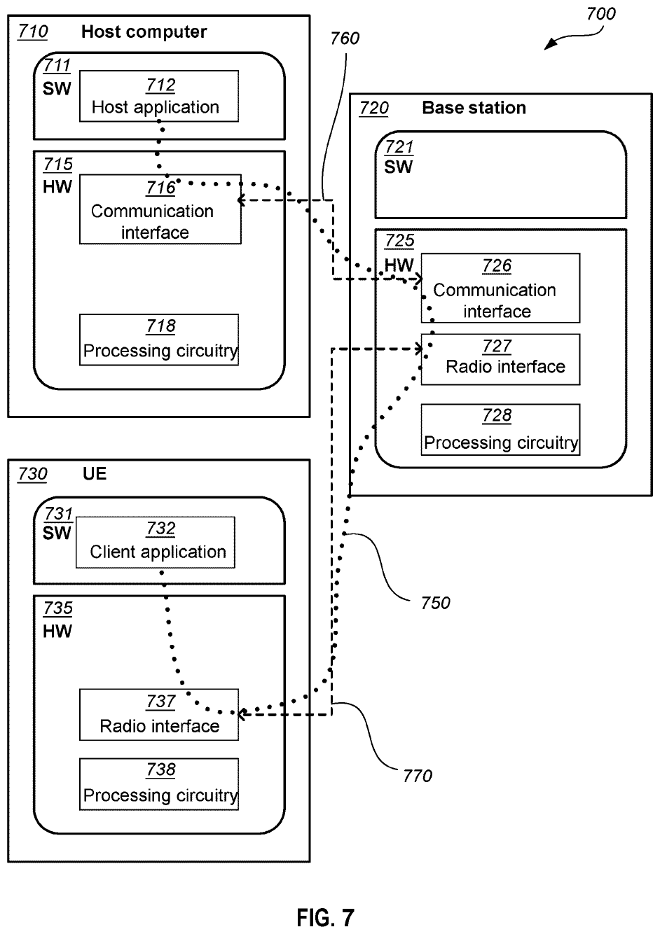

In relation to FIGS. 7, 8, 9, 10, and 11, which are described next, it may be understood that a UE is an example of the first wireless device 131, and that any description provided for the UE equally applies to the first wireless device 131. It may be also understood that the base station is an example of the first network node 111, and that any description provided for the base station equally applies to the first network node 111.

FIG. 7: Host Computer Communicating via a Base Station with a User Equipment Over a Partially Wireless Connection in Accordance with Some Embodiments

Example implementations, in accordance with an embodiment, of the first wireless device 131, e.g., a UE, the first network node 111, e.g., a base station and host computer discussed in the preceding paragraphs will now be described with reference to FIG. 7. In communication system 700, such as the wireless communications network 100, host computer 710 comprises hardware 715 including communication interface 716 configured to set up and maintain a wired or wireless connection with an interface of a different communication device of communication system 700. Host computer 710 further comprises processing circuitry 718, which may have storage and/or processing capabilities. In particular, processing circuitry 718 may comprise one or more programmable processors, application-specific integrated circuits, field programmable gate arrays or combinations of these (not shown) adapted to execute instructions. Host computer 710 further comprises software 711, which is stored in or accessible by host computer 710 and executable by processing circuitry 718. Software 711 includes host application 712. Host application 712 may be operable to provide a service to a remote user, such as UE 730 connecting via OTT connection 750 terminating at UE 730 and host computer 710. In providing the service to the remote user, host application 712 may provide user data which is transmitted using OTT connection 750.

Communication system 700 further includes the first network node 111, exemplified in FIG. 7 as a base station 720 provided in a telecommunication system and comprising hardware 725 enabling it to communicate with host computer 710 and with UE 730. Hardware 725 may include communication interface 726 for setting up and maintaining a wired or wireless connection with an interface of a different communication device of communication system 700, as well as radio interface 727 for setting up and maintaining at least wireless connection 770 with the first wireless device 131, exemplified in FIG. 7 as a UE 730 located in a coverage area (not shown in FIG. 7) served by base station 720. Communication interface 726 may be configured to facilitate connection 760 to host computer 710. Connection 760 may be direct or it may pass through a core network (not shown in FIG. 7) of the telecommunication system and/or through one or more intermediate networks outside the telecommunication system. In the embodiment shown, hardware 725 of base station 720 further includes processing circuitry 728, which may comprise one or more programmable processors, application-specific integrated circuits, field programmable gate arrays or combinations of these (not shown) adapted to execute instructions. Base station 720 further has software 721 stored internally or accessible via an external connection.

Communication system 700 further includes UE 730 already referred to. Its hardware 735 may include radio interface 737 configured to set up and maintain wireless connection 770 with a base station serving a coverage area in which UE 730 is currently located. Hardware 735 of UE 730 further includes processing circuitry 738, which may comprise one or more programmable processors, application-specific integrated circuits, field programmable gate arrays or combinations of these (not shown) adapted to execute instructions. UE 730 further comprises software 731, which is stored in or accessible by UE 730 and executable by processing circuitry 738. Software 731 includes client application 732. Client application 732 may be operable to provide a service to a human or non-human user via UE 730, with the support of host computer 710. In host computer 710, an executing host application 712 may communicate with the executing client application 732 via OTT connection 750 terminating at UE 730 and host computer 710. In providing the service to the user, client application 732 may receive request data from host application 712 and provide user data in response to the request data. OTT connection 750 may transfer both the request data and the user data. Client application 732 may interact with the user to generate the user data that it provides.

It is noted that host computer 710, base station 720 and UE 730 illustrated in FIG. 7 may be similar or identical to host computer 630, one of base stations 612a, 612b, 612c and one of UEs 691, 692 of FIG. 6, respectively. This is to say, the inner workings of these entities may be as shown in FIG. 7 and independently, the surrounding network topology may be that of FIG. 6.

In FIG. 7, OTT connection 750 has been drawn abstractly to illustrate the communication between host computer 710 and UE 730 via base station 720, without explicit reference to any intermediary devices and the precise routing of messages via these devices. Network infrastructure may determine the routing, which it may be configured to hide from UE 730 or from the service provider operating host computer 710, or both. While OTT connection 750 is active, the network infrastructure may further take decisions by which it dynamically changes the routing (e.g., on the basis of load balancing consideration or reconfiguration of the network).

Wireless connection 770 between UE 730 and base station 720 is in accordance with the teachings of the embodiments described throughout this disclosure. One or more of the various embodiments improve the performance of OTT services provided to UE 730 using OTT connection 750, in which wireless connection 770 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 750 between host computer 710 and UE 730, in response to variations in the measurement results. The measurement procedure and/or the network functionality for reconfiguring OTT connection 750 may be implemented in software 711 and hardware 715 of host computer 710 or in software 731 and hardware 735 of UE 730, or both. In embodiments, sensors (not shown) may be deployed in or in association with communication devices through which OTT connection 750 passes; the sensors may participate in the measurement procedure by supplying values of the monitored quantities exemplified above, or supplying values of other physical quantities from which software 711, 731 may compute or estimate the monitored quantities. The reconfiguring of OTT connection 750 may include message format, retransmission settings, preferred routing etc.; the reconfiguring need not affect base station 720, and it may be unknown or imperceptible to base station 720. Such procedures and functionalities may be known and practiced in the art. In certain embodiments, measurements may involve proprietary UE signaling facilitating host computer 710's measurements of throughput, propagation times, latency and the like. The measurements may be implemented in that software 711 and 731 causes messages to be transmitted, in particular empty or ‘dummy’ messages, using OTT connection 750 while it monitors propagation times, errors etc.

The first wireless device 131 embodiments relate to FIG. 2, FIG. 5 and FIGS. 6-11.

The first wireless device 131 may comprise an arrangement as shown in FIG. 4 or in FIG. 7.

The first wireless device 131 may also be configured to communicate user data with a host application unit in a host computer 710, e.g., via another link such as 760.

The first wireless device 131 may comprise an interface unit to facilitate communications between the first wireless device 131 and other nodes or devices, e.g., the first network node 111, the host computer 710, or any of the other nodes. In some particular examples, the interface may, for example, include a transceiver configured to transmit and receive radio signals over an air interface in accordance with a suitable standard.

The first network node 111 embodiments relate to FIG. 3, FIG. 5 and FIGS. 6-11.

The first network node 111 may comprise an arrangement as shown in FIG. 5 or in FIG. 7.

The first network node 111 may also be configured to communicate user data with a host application unit in a host computer 710, e.g., via another link such as 760.

The first network node 111 may comprise an interface unit to facilitate communications between the first network node 111 and other nodes or devices, e.g., the first wireless device 131, the host computer 710, or any of the other nodes. In some particular examples, the interface may, for example, include a transceiver configured to transmit and receive radio signals over an air interface in accordance with a suitable standard.

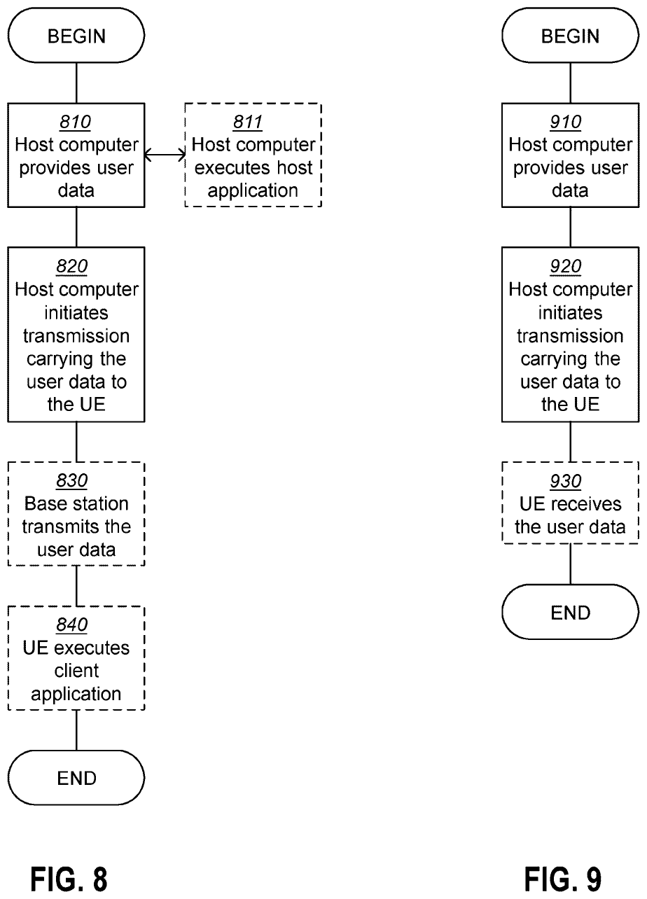

FIG. 8: Methods Implemented in a Communication System Including a Host Computer, a Base Station and a User Equipment in Accordance with Some Embodiments

FIG. 8 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 8 will be included in this section. In step 810, the host computer provides user data. In substep 811 (which may be optional) of step 810, the host computer provides the user data by executing a host application. In step 820, the host computer initiates a transmission carrying the user data to the UE. In step 830 (which may be optional), the base station transmits to the UE the user data which was carried in the transmission that the host computer initiated, in accordance with the teachings of the embodiments described throughout this disclosure. In step 840 (which may also be optional), the UE executes a client application associated with the host application executed by the host computer.

FIG. 9: Methods Implemented in a Communication System Including a Host Computer, a Base Station and a User Equipment in Accordance with Some Embodiments

FIG. 9 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 9 will be included in this section. In step 910 of the method, the host computer provides user data. In an optional substep (not shown) the host computer provides the user data by executing a host application. In step 920, the host computer initiates a transmission carrying the user data to the UE. The transmission may pass via the base station, in accordance with the teachings of the embodiments described throughout this disclosure. In step 930 (which may be optional), the UE receives the user data carried in the transmission.

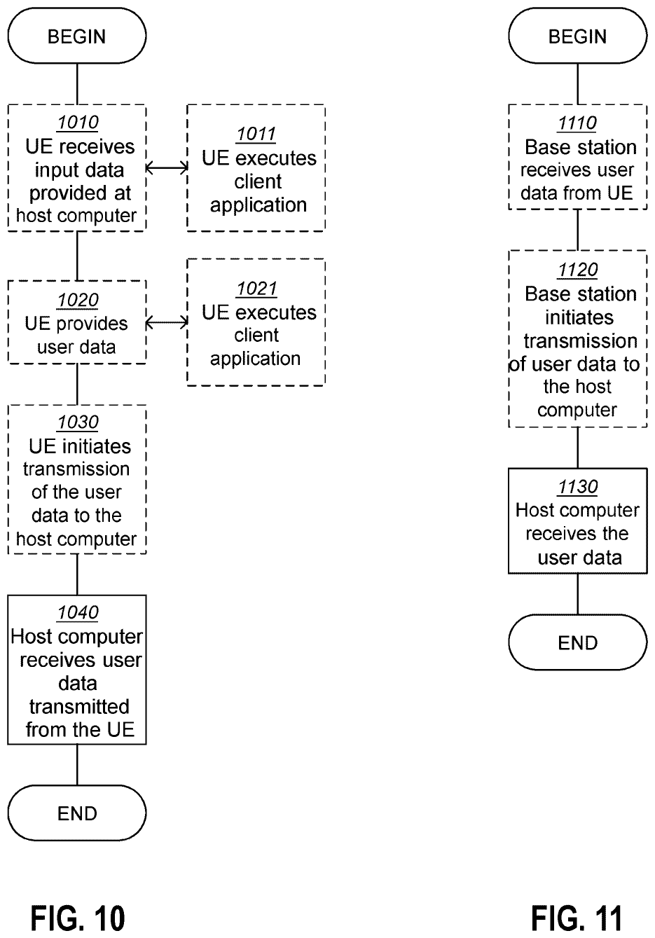

FIG. 10: Methods Implemented in a Communication System Including a Host Computer, a Base Station and a User Equipment in Accordance with Some Embodiments

FIG. 10 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 10 will be included in this section. In step 1010 (which may be optional), the UE receives input data provided by the host computer. Additionally or alternatively, in step 1020, the UE provides user data. In substep 1021 (which may be optional) of step 1020, the UE provides the user data by executing a client application. In substep 1011 (which may be optional) of step 1010, the UE executes a client application which provides the user data in reaction to the received input data provided by the host computer. In providing the user data, the executed client application may further consider user input received from the user. Regardless of the specific manner in which the user data was provided, the UE initiates, in substep 1030 (which may be optional), transmission of the user data to the host computer. In step 1040 of the method, the host computer receives the user data transmitted from the UE, in accordance with the teachings of the embodiments described throughout this disclosure.

FIG. 11: Methods Implemented in a Communication System Including a Host Computer, a Base Station and a User Equipment in Accordance with Some Embodiments

FIG. 11 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 11 will be included in this section. In step 1110 (which may be optional), in accordance with the teachings of the embodiments described throughout this disclosure, the base station receives user data from the UE. In step 1120 (which may be optional), the base station initiates transmission of the received user data to the host computer. In step 1130 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the first network node 111.
5. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform one or more of the actions described herein as performed by the first network node 111.
6. The communication system of embodiment 5, further including the base station.
7. The communication system of embodiment 6, further including the UE, wherein the UE is configured to communicate with the base station.
8. The communication system of embodiment 7, wherein:
   the processing circuitry of the host computer is configured to execute a host application, thereby providing the user data; and
   the UE comprises processing circuitry configured to execute a client application associated with the host application.
11. A method implemented in a base station, comprising one or more of the actions described herein as performed by the first network node 111.
15. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs one or more of the actions described herein as performed by the first network node 111.
16. The method of embodiment 15, further comprising:
   at the base station, transmitting the user data.
17. The method of embodiment 16, wherein the user data is provided at the host computer by executing a host application, the method further comprising:
   at the UE, executing a client application associated with the host application.
21. A user equipment (UE) configured to communicate with a base station, the UE comprising a radio interface and processing circuitry configured to perform one or more of the actions described herein as performed by the first wireless device 131.
25. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's processing circuitry configured to perform one or more of the actions described herein as performed by the first wireless device 131.
26. The communication system of embodiment 25, further including the UE.
27. The communication system of embodiment 26, wherein the cellular network further includes a base station configured to communicate with the UE.
28. The communication system of embodiment 26 or 27, wherein:
   the processing circuitry of the host computer is configured to execute a host application, thereby providing the user data; and
   the UE's processing circuitry is configured to execute a client application associated with the host application.
31. A method implemented in a user equipment (UE), comprising one or more of the actions described herein as performed by the first wireless device 131.
35. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs one or more of the actions described herein as performed by the first wireless device 131.
36. The method of embodiment 35, further comprising:
   at the UE, receiving the user data from the base station.
41. A user equipment (UE) configured to communicate with a base station, the UE comprising a radio interface and processing circuitry configured to perform one or more of the actions described herein as performed by the first wireless device 131.
45. A communication system including a host computer comprising:
   a communication interface configured to receive user data originating from a transmission from a user equipment (UE) to a base station,
   wherein the UE comprises a radio interface and processing circuitry, the UE's processing circuitry configured to: perform one or more of the actions described herein as performed by the first wireless device 131.
46. The communication system of embodiment 45, further including the UE.
47. The communication system of embodiment 46, further including the base station, wherein the base station comprises a radio interface configured to communicate with the UE and a communication interface configured to forward to the host computer the user data carried by a transmission from the UE to the base station.
48. The communication system of embodiment 46 or 47, wherein:
   the processing circuitry of the host computer is configured to execute a host application; and
   the UE's processing circuitry is configured to execute a client application associated with the host application, thereby providing the user data.
49. The communication system of embodiment 46 or 47, wherein:
   the processing circuitry of the host computer is configured to execute a host application, thereby providing request data; and
   the UE's processing circuitry is configured to execute a client application associated with the host application, thereby providing the user data in response to the request data.
51. A method implemented in a user equipment (UE), comprising one or more of the actions described herein as performed by the first wireless device 131.
52. The method of embodiment 51, further comprising:
   providing user data; and
   forwarding the user data to a host computer via the transmission to the base station.
55. A method implemented in a communication system including a host computer, a base station and a user equipment (UE), the method comprising:
   at the host computer, receiving user data transmitted to the base station from the UE, wherein the UE performs one or more of the actions described herein as performed by the first wireless device 131.
56. The method of embodiment 55, further comprising:
   at the UE, providing the user data to the base station.
57. The method of embodiment 56, further comprising:
   at the UE, executing a client application, thereby providing the user data to be transmitted; and
   at the host computer, executing a host application associated with the client application.
58. The method of embodiment 56, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
61. A base station configured to communicate with a user equipment (UE), the base station comprising a radio interface and processing circuitry configured to perform one or more of the actions described herein as performed by the first network node 111.
65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the first network node 111.
66. The communication system of embodiment 65, further including the base station.
67. The communication system of embodiment 66, further including the UE, wherein the UE is configured to communicate with the base station.
68. The communication system of embodiment 67, wherein:
   the processing circuitry of the host computer is configured to execute a host application;
   the UE is configured to execute a client application associated with the host application, thereby providing the user data to be received by the host computer.
71. A method implemented in a base station, comprising one or more of the actions described herein as performed by the first network node 111.
75. A method implemented in a communication system including a host computer, a base station and a user equipment (UE), the method comprising:
   at the host computer, receiving, from the base station, user data originating from a transmission which the base station has received from the UE, wherein the UE performs one or more of the actions described herein as performed by the first wireless device 131.
76. The method of embodiment 75, further comprising:
   at the base station, receiving the user data from the UE.
77. The method of embodiment 76, further comprising:
   at the base station, initiating a transmission of the received user data to the host computer.

1. A method performed by a first wireless device (131), the method being for handling an indication, the first wireless device (131) operating in a wireless communications network (100), and the method comprising:
obtaining (201) first information indicating whether or not a first cell (121) supports service to the first wireless device (131) having a reduced capability with respect to a group of second wireless devices (132), and
sending (203) a first indication to a first network node (111), wherein the first wireless device (131) is served by the first network node (111) and the first cell (121) is served by a second network node (112), wherein the first indication indicates one or more measurements performed by the first wireless device (131) on one or more cells (120), wherein, with the proviso the first information indicates the first cell (121) lacks support for the first wireless device (131) having the reduced capability, the first wireless device (131) refrains from indicating any measurements performed on the first cell (121) to the first network node (111) in the first indication.

2. The method according to claim 1, wherein one of:
with the proviso the first information indicates the first cell (121) lacks support for the first wireless device (131) having the reduced capability, the first wireless device (131) sends any measurements performed on the first cell (121) to the first network node (111) in a different indication than the first indication, and
with the proviso the first information indicates the first cell (121) lacks support for the first wireless device (131) having the reduced capability, the first wireless device (131) refrains from indicating any measurements performed on the first cell (121) to the first network node (111) in any indication.

3. The method according to claim 2, wherein one of:
a) the first indication is a first information element and the different indication is a different information element, or any indication is any information element,
b) the first indication is a first report and the different indication is a different report, or any indication is any report, and
the first indication is sent in a Radio Resource Control, RRC, message.

4. The method according to claim 1, wherein the first information is a configuration from the first network node (111).

5. The method according to claim 4, wherein the configuration configures the first wireless device (131) to perform measurements on frequencies where cells supporting service to wireless devices with reduced capability operate.

6. The method according to claim 1, wherein the first information is obtained in a broadcast from the first cell (121).

7. The method according to claim 1, further comprising:
determining (202) whether or not the first cell (121) supports service to the first wireless device (131) having the reduced capability with respect to the group of second wireless devices (132), based on the obtained first information.

8. The method according to claim 7, wherein the first wireless device (131) performs at least one of the determining (202) and the sending (203), with the proviso that an instruction is received from the first network node (111) instructing the first wireless device (131) to perform the determination.

9. The method according to claim 7, wherein at least one of:
the first information is comprised in Master Information Block, MIB,
the first information is comprised in System Information Block, SIB,
the first information is comprised in SIB3/4,
wherein the first wireless device (131) determines the first cell (121) lacks support for the service to the first wireless device (131) having the reduced capability based on the first information lacking an indicator explicitly indicating support for the reduced capability is provided, and
the first wireless device (131) is a RedCap User Equipment, UE.

10. The method according to claim 2, further comprising:
initiating (204) performing a handover to the first cell (121) based on the sent first indication or the indication different than the first indication.

11. A method performed by a first network node (111), the method being for handling an indication, first network node (111) operating in a wireless communications network (100), and the method comprising:
sending (304), to a first wireless device (131), first information indicating whether or not a first cell (121) supports service to the first wireless device (131) having a reduced capability with respect to a group of second wireless devices (132), wherein the first network node (111) serves the first wireless device (131) and the first cell (121) is served by a second network node (112), and
receiving (305) a first indication from the first wireless device (131), the first indication indicating one or more measurements performed by the first wireless device (131) on one or more cells (120), wherein, with the proviso the first information indicates the first cell (121) lacks support for the first wireless device (131) having the reduced capability, the first wireless device (131) refrains from indicating any measurements performed on the first cell (121) to the first network node (111) in the first indication.

12. The method according to claim 11, wherein one of:
with the proviso the first information indicates the first cell (121) lacks support for the first wireless device (131) having the reduced capability, the first network node (111) receives any measurements performed by the first wireless device (131) on the first cell (121) in a different indication than the first indication, and
with the proviso the first information indicates the first cell (121) lacks support for the first wireless device (131) having the reduced capability, the first wireless device (131) refrains from indicating any measurements performed on the first cell (121) to the first network node (111) in any indication.

13. The method according to claim 12, wherein one of:
a) the first indication is a first information element and the different indication is a different information element, or any indication is any information element,
b) the first indication is a first report and the different indication is a different report, or any indication is any report, and
the first indication is received in a Radio Resource Control, RRC, message.

14. The method according to claim 11, wherein the first information is a configuration from the first network node (111).

15. The method according to any claim 14, wherein the configuration configures the first wireless device (131) to perform measurements on frequencies where cells supporting service to wireless devices with reduced capability operate.

16. The method according to claim 11, further comprising:
obtaining (303) the first information from a second network node (112) serving the first cell (121), and wherein the sent first information is the obtained first information.

17-20. (canceled)

21. A first wireless device (131), for handling an indication, the first wireless device (131) being configured to operate in a wireless communications network (100), and the first wireless device (131) being further configured to:
obtain first information configured to indicate whether or not a first cell (121) is configured to support service to a first wireless device (131) being configured to have a reduced capability with respect to a group of second wireless devices (132), and
send a first indication to a first network node (111), wherein the first wireless device (131) is configured to be served by the first network node (111) and the first cell (121) is configured to be served by a second network node (112), wherein the first indication is configured to indicate one or more measurements configured to be performed by the first wireless device (131) on one or more cells (120), wherein, with the proviso the first information is configured to indicate the first cell (121) lacks support for the first wireless device (131) configured to have the reduced capability, the first wireless device (131) is configured to refrain from indicating any measurements configured to be performed on the first cell (121) to the first network node (111) in the first indication.

22. The first wireless device (131) according to claim 21, wherein one of:
with the proviso the first information is configured to indicate the first cell (121) lacks support for the first wireless device (131) configured to have the reduced capability, the first wireless device (131) is configured to send any measurements configured to be performed on the first cell (121) to the first network node (111) in a different indication than the first indication, and
with the proviso the first information is configured to indicate the first cell (121) lacks support for the first wireless device (131) configured to have the reduced capability, the first wireless device (131) is configured to refrain from indicating any measurements performed on the first cell (121) to the first network node (111) in any indication.

23. The first wireless device (131) according to claim 22, wherein one of:
a) the first indication is configured to be a first information element and the different indication is configured to be a different information element, or any indication is configured to be any information element,
b) the first indication is configured to be a first report and the different indication is configured to be a different report, or any indication is configured to be any report, and
the first indication is configured to be sent in a Radio Resource Control, RRC, message.

24. The first wireless device (131) according to claim 21, wherein the first information is configured to be a configuration from the first network node (111).

25-40. (canceled)
